(19) United States
(12) Patent Application Publication
(10) Pub. No.: US 2015/0070502 A1
(43) Pub. Date: Mar. 12, 2015

(54) VEHICLE DISPLAY APPARATUS

(71) Applicant: HONDA MOTOR CO., LTD., Tokyo (JP)

(72) Inventors: Hisashi Murayama, Asaka-shi (JP); Megumi Nagumo, Kawagoe-shi (JP)

(21) Appl. No.: 14/478,067

(22) Filed: Sep. 5, 2014

(30) Foreign Application Priority Data
Sep. 11, 2013 (JP) 2013-188594

(51) Int. Cl. B60R 1/00; H04N 7/18

(52) U.S. Cl. CPC B60R 1/00; H04N 7/183; B60R 1/006; B60R 2300/205; B60R 2300/60; B60R 2300/304; B60R 2300/802
USPC 348/148

(57) ABSTRACT

A vehicle display apparatus includes: a first display device that displays a first virtual image at a position of a first distance from an eye position of a vehicle driver to forward of the vehicle; and a second display device that displays a second virtual image at a position of a second distance shorter than the first distance from the eye position of the vehicle driver to forward of the vehicle. The first display device displays a captured image output from an image pickup device that captures an image of the surroundings of the vehicle as the first virtual image.

### CROSS-REFERENCE TO RELATED APPLICATION

Priority is claimed on Japanese Patent Application No. 2013-188594, filed Sep. 11, 2013, the content of which is incorporated herein by reference.

### BACKGROUND OF THE INVENTION

1. Field of the Invention

The present invention relates to a vehicle display apparatus.

2. Description of Related Art

Conventionally, a vehicle display apparatus that displays an image taken by a camera attached to a door mirror on a front passenger seat side, on a display screen which is movable to a left and right symmetric position about the driver's seat with respect to a door mirror on a driver seat side, has been known (for example, refer to Japanese Unexamined Patent Application, First Publication No. 2008-213759).

### SUMMARY OF THE INVENTION

The display screen of the vehicle display apparatus according to the above-described conventional technique is arranged on a nearer side to the driver than the door mirror on the front passenger seat side. Therefore, when a rear side of the vehicle is to be confirmed by the display screen, there is a problem in that a focal point difference between at the time of viewing the front side of the vehicle and at the time of viewing the rear side of the vehicle increases, as compared to with a door mirror on the front passenger seat side. Moreover, there is a problem in that it is necessary to provide a movable mechanism for moving of the display device body, making the device configuration complicated.

In view of the above situation, aspects of the present invention are aimed at providing a vehicle display apparatus that can reduce the focal point difference between at the time of viewing the front side of the vehicle and at the time of viewing the rear side of the vehicle, and a line-of-sight moving distance.

In order to solve the above problems and achieve the object, the present invention has adopted the following aspects.

(1) A vehicle display apparatus according to a first aspect of the present invention comprises: a first display device that displays a first virtual image at a position of a first distance from an eye position of a vehicle driver to forward of the vehicle; and a second display device that displays a second virtual image at a position of a second distance shorter than the first distance from the eye position of the vehicle driver to forward of the vehicle. The first display device displays a captured image output from an image pickup device that captures an image of the surroundings of the vehicle as the first virtual image.

(2) In the aspect of (1) above, the first display device may display a pair of virtual images as the first virtual image at positions substantially line-symmetric widthwise about the second virtual image as seen by the driver.

(3) In the aspect of (2) above, the first display device may display the pair of virtual images substantially at the same positions in a front-back direction of the vehicle.

(4) In an aspect of any one of the aspects (1) to (3) above, the image pickup device may output the captured image of an external region of the vehicle on a rear side that is visible by the driver by a door mirror of the vehicle.

According to the vehicle display apparatus in the aspect described in (1) above, the first virtual image and the second virtual image can be stereoscopically superimposed and displayed according to an order of priority or the like, so that long distance display is possible without requiring an actual space distance, thereby enabling to prevent the device from becoming large. Moreover, by displaying the captured image of the surroundings of the vehicle as the first virtual image at a position on a farther side than the second virtual image as seen by the driver so as to be brought closer to an outside field of view, the captured image can be easily seen. Furthermore the focal point difference between a forward field of view and the captured image (the first virtual image), and line-of-sight movement can be reduced.

In the case of (2) or (3) above, by displaying the captured image of the surroundings on the left and right of the vehicle as the pair of left and right virtual images, the captured image of the surroundings on the left and right sides can be easily recognized by the driver.

In the case of (4) above, by displaying the first virtual image of the captured image on the forward side as seen by the driver and farther ahead than the door mirror so as to be brought closer to the outside field of view, the captured image can be easily seen, and the focal point difference between the forward field of view and the captured image, and the line-of-sight movement can be reduced.

### BRIEF DESCRIPTION OF THE DRAWINGS

FIG. 1 is a configuration diagram of a vehicle display apparatus according to an embodiment of the present invention, being a diagram showing positions of first virtual images and a second virtual image visible by a driver.

FIG. 2 is a perspective view of the vehicle display apparatus according to the embodiment of the present invention, being a diagram showing the positions of the first virtual images and the second virtual image visible by the driver.

FIG. 3 is a diagram showing the positions of the first virtual images and the second virtual image of the vehicle display apparatus according to the embodiment of the present invention, FIG. 3 (A) being a plan view, and FIG. 3 (B) being a perspective view.

FIG. 4 is a diagram showing an example of an operation state of the vehicle display apparatus according to the embodiment of the present invention, FIG. 4 (A) being a sectional view, and FIG. 4 (B) being a perspective view.

FIG. 5 is a diagram showing an example of the operation state of the vehicle display apparatus according to the embodiment of the present invention, FIG. 5 (A) being a sectional view, and FIG. 5 (B) being a perspective view.

FIG. 6 is a diagram showing an example of the operation state of the vehicle display apparatus according to the embodiment of the present invention, FIG. 6 (A) being a sectional view, and FIG. 6 (B) being a perspective view.

### DETAILED DESCRIPTION OF THE INVENTION

Hereunder, a vehicle display apparatus according to an embodiment of the present invention will be described with reference to the accompanying drawings.

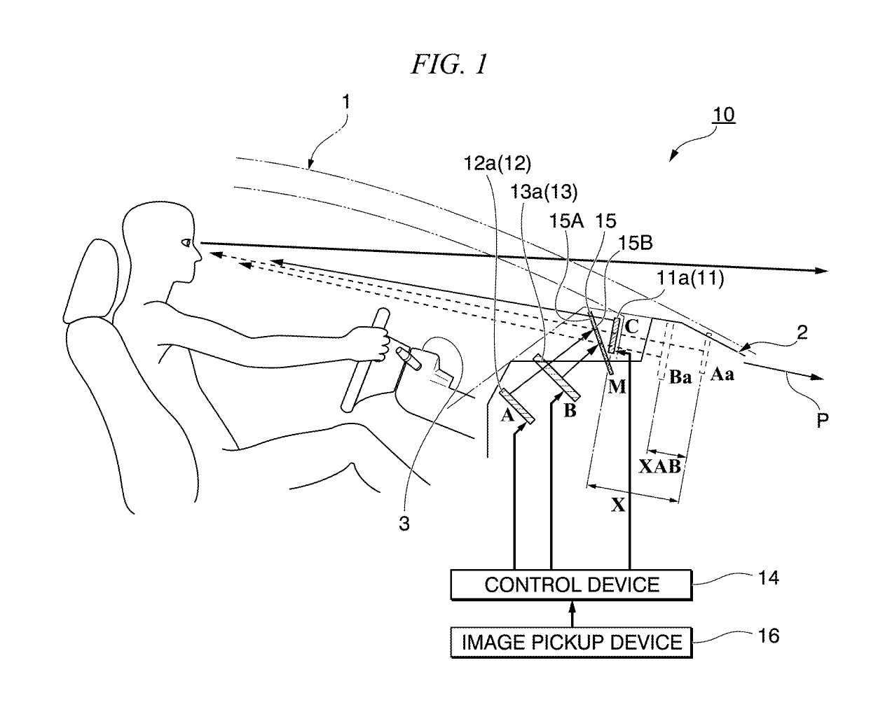

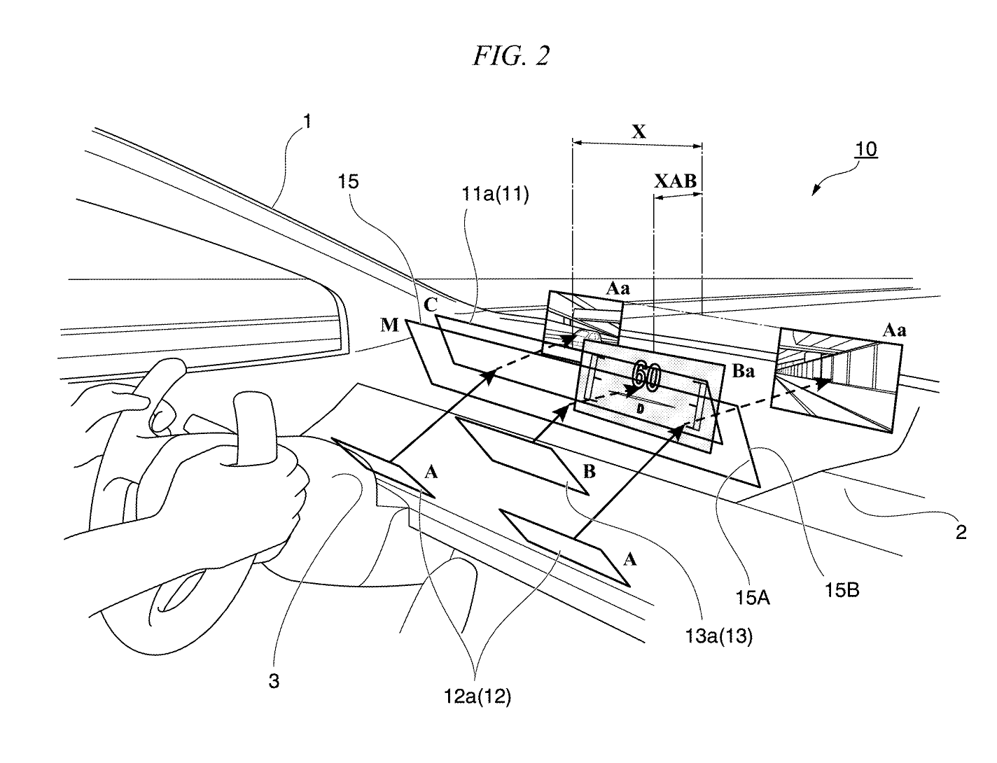

As shown in FIG. 1 and FIG. 2, a vehicle display apparatus 10 according to the present embodiment is installed on an instrument panel 2 provided at the front of a driver's seat (not shown) of a vehicle 1. The vehicle display apparatus 10 comprises a real image display device 11, a first virtual image display device (first display device) 12, a second virtual image display device (second display device) 13, and a control device 14.

The real image display device 11 comprises a liquid crystal display (C) 11a, made for example, by a TFT (thin film transistor) liquid crystal. The liquid crystal display (C) 11a is arranged so as to face the front of the driver at a predetermined position in a predetermined direction P towards the front of the vehicle, visible by the driver seated on the driver's seat. The real image display device 11 displays, for example, attention attracting information, alarm information, and entertainment information, on the liquid crystal display (C) 11a.

The liquid crystal display (C) 11a is constituted by liquid crystal with a background being not see-through (that is, non-transmissive) so that, for example, the driver cannot view a portion on the far side as seen by the driver, and a light blocking effect with respect to a display region is ensured.

The TFT liquid crystal may be liquid crystal with the background being see-through.

The first virtual image display device 12 and the second virtual image display device 13 comprise a common mirror member 15 such as a half mirror. The mirror member 15 is arranged at a position on the nearer side to the driver than the liquid crystal display (C) 11a in the predetermined direction P so that the liquid crystal display (C) 11a is positioned behind the mirror member 15 as seen by the driver seated on the driver's seat. The mirror member 15 comprises a surface 15A inclined such that an upper part thereof protrudes further toward the nearer side to the driver than a lower part thereof. The mirror member 15 reflects light entering from the near side to the driver into the surface 15A, and causes light entering from the far side from the driver into a rear surface 15B to be transmitted toward the near side to the driver.

The first virtual image display device 12 comprises a pair of first virtual-image liquid crystal displays (A, A) 12a and 12a, made for example by a TFT (thin film transistor) liquid crystal. The pair of first virtual-image liquid crystal displays (A, A) 12a and 12a are arranged at positions substantially line-symmetric widthwise, about a steering column 3 so that a display image can be projected on the surface 15A of the mirror member 15. The pair of first virtual-image liquid crystal displays (A, A) 12a and 12a are arranged so that the respective display images are reflected toward a position of the eyes of the driver seated on the driver's seat, by the surface 15A of the mirror member 15 and are visible by the driver as respective virtual images (first virtual images) Aa at a pair of left and right first positions set behind the liquid crystal display (C) 11a as seen by the driver.

The first virtual image display device 12 displays, for example, a captured image output from an image pickup device 16 that captures an image of the surroundings of the vehicle 1 on each of the pair of first virtual-image liquid crystal displays (A, A) 12a and 12a. The surroundings of the vehicle 1 are, for example, an external region on a rear side of the vehicle 1 visible by the driver by means of door mirrors (not shown) of the vehicle 1, or an external region on a rear side of or around the vehicle 1 visible by the driver directly or via another mirror, or an external region being out of the driver's line of vision.

The second virtual image display device 13 comprises a second virtual-image liquid crystal display (B) 13a, made for example by a TFT (thin film transistor) liquid crystal. The second virtual-image liquid crystal display (B) 13a is arranged at a position behind the steering column 3 as seen by the driver seated on the driver's seat so that a display image can be projected onto the surface 15A of the mirror member 15. The second virtual-image liquid crystal display (B) 13a is arranged so that the display image is reflected toward a position of the eyes of the driver seated on the driver seat, by the surface 15A of the mirror member 15 and is visible by the driver as a virtual image (second virtual image) Ba at a second position set behind the liquid crystal display (C) 11a as seen by the driver.

The second virtual image display device 13 displays, for example, pieces of information of the vehicle 1 such as the engine speed of the vehicle 1, the speed, the fuel level, and the engine water temperature meter, on the second virtual-image liquid crystal display (B) 13a.

The pair of first virtual-image liquid crystal displays (A, A) 12a and 12a are arranged father away from the surface 15A of the mirror member 15 than the second virtual-image liquid crystal display (B) 13a.

As a result, each of the pair of first positions is set away from the liquid crystal display (C) 11a on the farther side from the driver than the second position in the predetermined direction P. For example, because the second position is shifted from the respective first positions by a distance XAB toward the near side to the driver with respect to a distance X from the liquid crystal display (C) 11a to the respective first positions in the predetermined direction P, a distance from the liquid crystal display (C) 11a to the second position is (X-XAB).

That is to say, the captured image of the surroundings, information of the vehicle 1, and the like are generated as virtual images by the mirror member 15 arranged on the nearer side than the liquid crystal display (C) 11a. As a result, it is set such that an alarm display or the like of the liquid crystal display (C) 11a can be seen on the nearer side than the captured image of the surroundings and the information of the vehicle 1, and such that the captured image of the surroundings and the information of the vehicle 1 can be seen through the alarm display.

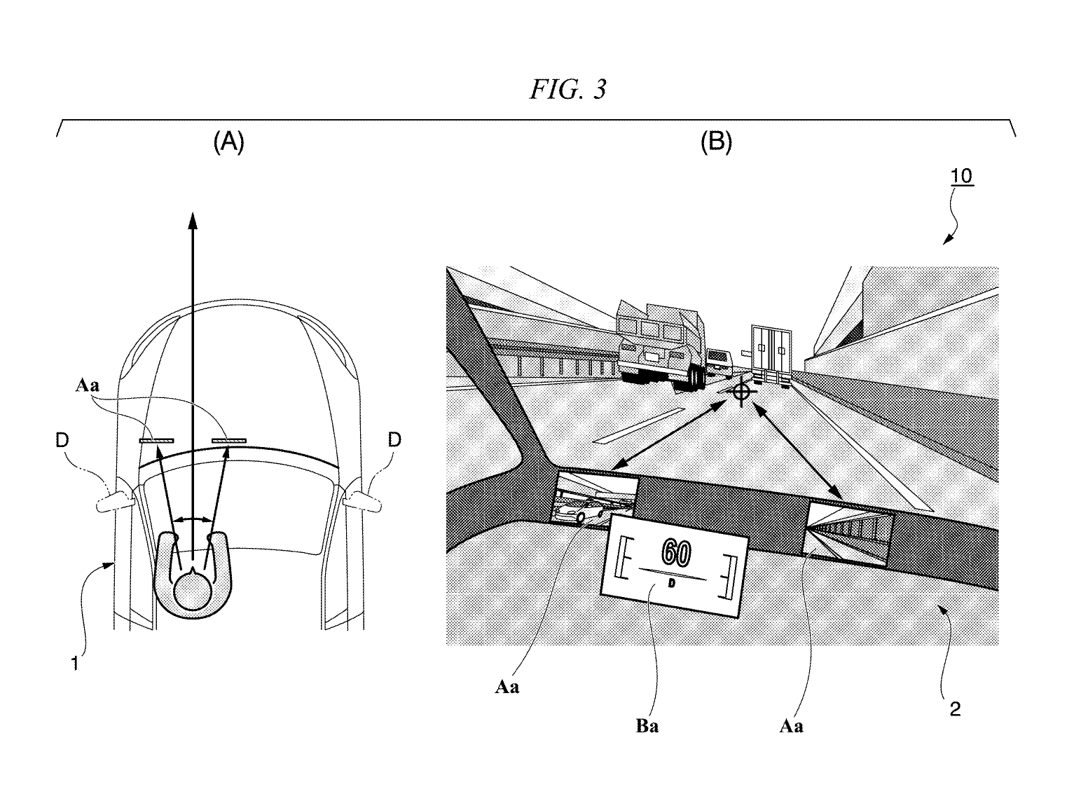

Moreover, as shown in FIG. 3 (A) and FIG. 3 (B), a pair of first virtual images Aa and Aa at a pair of left and right first positions as seen by the driver, are arranged more to the center in the widthwise direction and more to the front side in the front-back direction of the vehicle 1, than left and right virtual door mirrors D and D of the vehicle 1. The pair of first virtual images Aa and Aa are arranged away from each other in the widthwise direction of the vehicle 1 with a predetermined interval narrower than a widthwise interval between the left and right door mirrors of the vehicle 1. Furthermore, a second virtual image Ba at the second position is arranged at a central position between the pair of first vertical images Aa and Aa in the widthwise direction of the vehicle 1, as seen by the driver.

The control device 14 controls respective displays of the real image display device 11, the first virtual image display device 12, and the second virtual image display device 13. Moreover, the control device 14 controls image pickup of the image pickup device 16.

The vehicle display apparatus 10 according to the present embodiment comprises the above configuration. Next is a description of a display example by a display operation of the vehicle display apparatus 10.

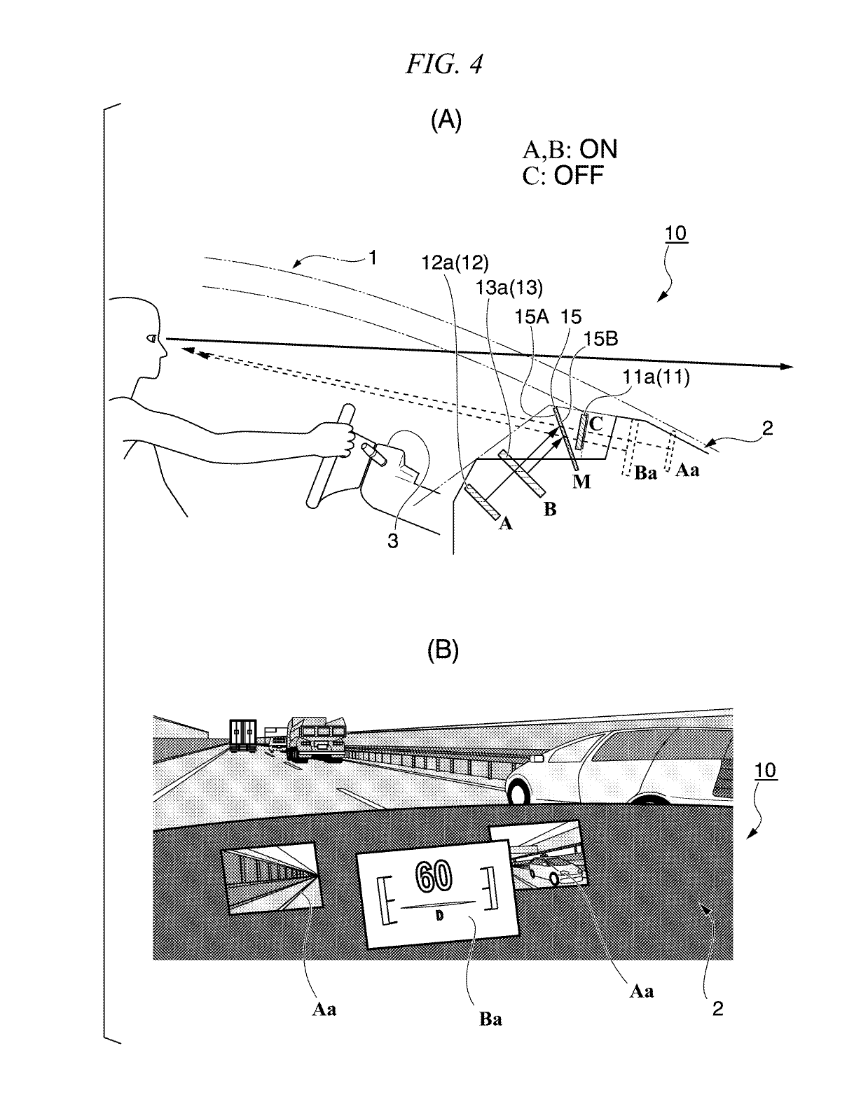

For example, during traveling of the vehicle 1 in response to a driving operation of the driver, as shown in FIG. 4 (A) and FIG. 4 (B), the first virtual image display device 12 in an on state displays the captured image of the left and right rear sides of the vehicle 1 output from the image pickup device 16 at the pair of first positions, as the pair of first virtual images Aa and Aa.

The second virtual image display device 13 in the on state displays pieces of information of the vehicle 1 such as the speed of the vehicle 1, the fuel level, and the engine water temperature meter at the second position, as the second virtual image Ba. As a result, the first virtual image display device 12 and the second virtual image display device 13 stereoscopically superimpose and display the pair of first virtual images Aa and Aa and the second virtual image Ba in the predetermined direction P. In this case, the driver can concentrate on driving without requiring to largely move the line of sight between the forward field of view and the first virtual images Aa of the captured image.

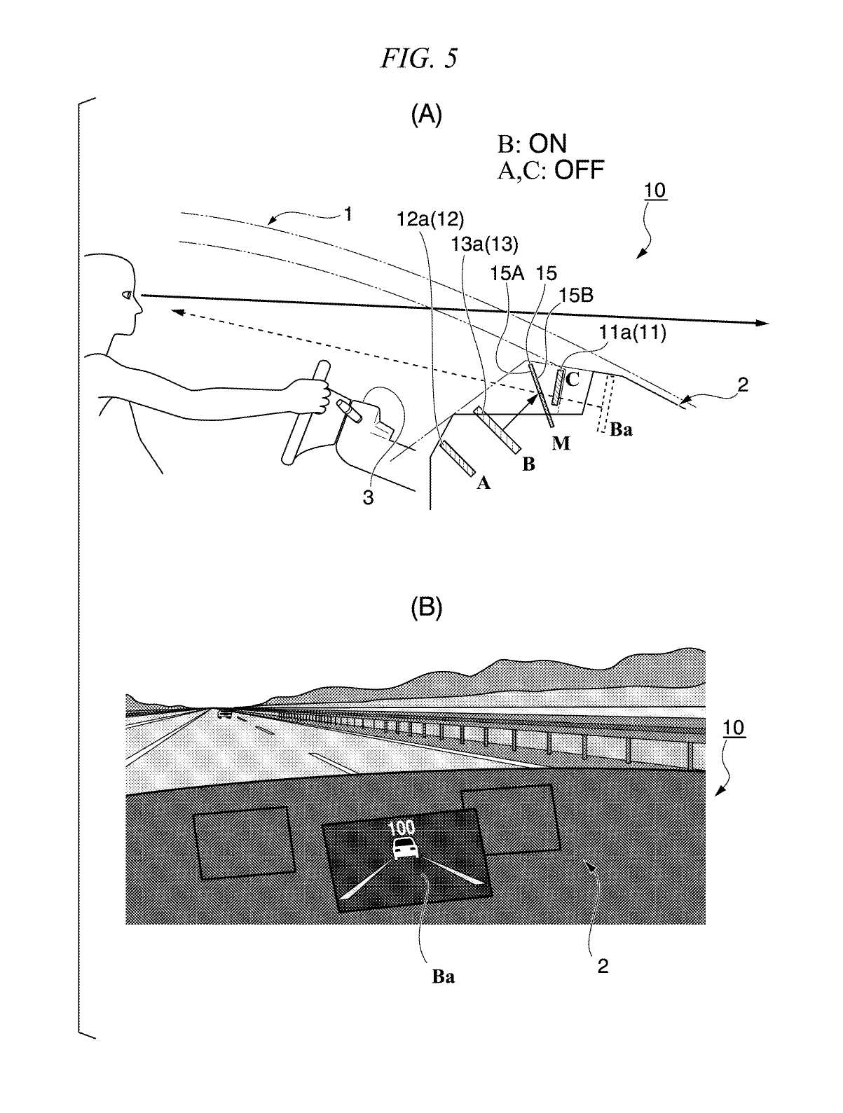

For example, during traveling of the vehicle 1 under semi-automatic operation by actuation of various drive assists such as constant speed traveling and lane departure prevention, as shown in FIG. 5 (A) and FIG. 5 (B), the real image display device 11 and the first virtual image display device 12 are in an off state, and the second virtual image display device 13 is in the on state. The second virtual image display device 13 in the on state displays information of a traveling track of the vehicle 1 (for example, the presence of a construction site) together with the information of the vehicle 1 such as the type of the drive assist in action and the speed of the vehicle 1, as the second virtual image Ba at the second position. The first virtual image display device 12 becomes the on state at the time of occurrence of a dangerous state, and displays the captured image of the surroundings of the vehicle 1 as the first virtual image Aa at the first position.

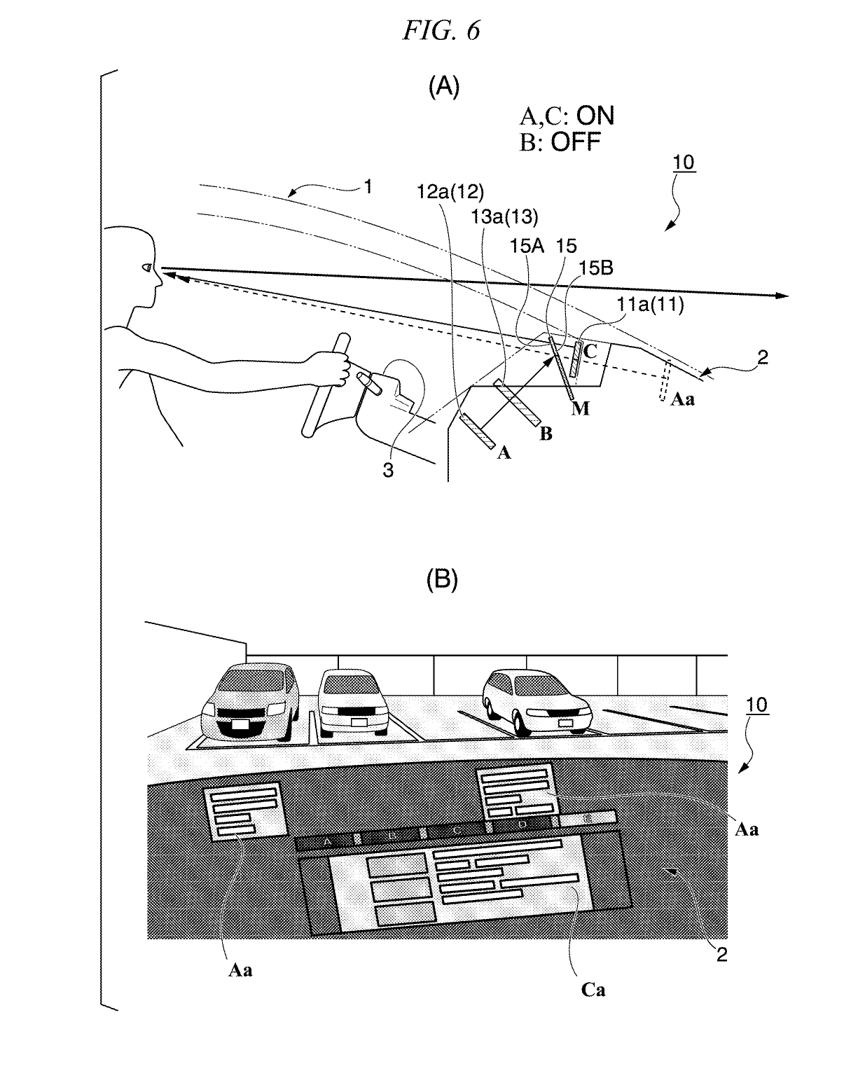

During parking of the vehicle 1, as shown in FIGS. 6 (A) and 6 (B), the second virtual image display device 13 stops the action, and the real image display device 11 displays the entertainment information as the real image. The first virtual image display device 12 displays detailed information of the entertainment information and accompanying information, as the pair of left and right first virtual images Aa and Aa at the pair of left and right first positions.

As described above, according to the vehicle display apparatus 10 according to the present embodiment, the first virtual images Aa and the second virtual image Ba can be stereoscopically superimposed and displayed according to the order of priority, so that long distance display is possible without requiring the actual space distance, thereby enabling to prevent the device from becoming large. Moreover, by displaying the captured image of the surroundings of the vehicle 1 as the first virtual images Aa at the position on the farther side than the second virtual image Ba as seen by the driver so as to be brought closer to the outside field of view, the captured image can be easily seen, and the driver can intuitionally recognize that the captured image relates to the information associated with the outside field of view. Furthermore the focal point difference between the forward field of view and the captured image (the first virtual image), and the line-of-sight movement can be reduced. Moreover, for example, when the first virtual image Aa is to be displayed outside of the vehicle, and the second virtual image Ba is to be displayed inside of the vehicle, zoning (classification of the information according to a display position) of the information to be displayed by the first virtual images Aa and the second virtual image Ba can be performed.

Moreover, by displaying the captured image of the left and right surroundings of the vehicle 1 as the pair of left and right virtual images, the driver can easily recognize the captured image of the left and right surroundings.

Furthermore, by displaying the first virtual image of the captured image further in front of the door mirror as seen by the driver, and farther ahead of the door mirror, the line-of-sight moving distance from the forward field of vision (for example, a change amount of look-down angle and horizontal angle) can be reduced, as compared to a case in which the driver actually views the door mirror. Moreover, the focal point difference between the forward field of view and the captured image can be reduced.

Furthermore, the presence of display and display contents of the first virtual images Aa and the second virtual image Ba can be changed according to the driving state of the vehicle 1, thereby enabling to perform appropriate drive assist.

As described above, the present embodiment shows only an example in implementing the present invention, and it is a matter of course that the present invention should not be interpreted as being limited to the embodiment described above.

What is claimed is:

1. A vehicle display apparatus comprising:
a first display device that displays a first virtual image at a position of a first distance from an eye position of a vehicle driver to forward of the vehicle; and
a second display device that displays a second virtual image at a position of a second distance shorter than the first distance from the eye position of the vehicle driver to forward of the vehicle,
wherein the first display device displays a captured image output from an image pickup device that captures an image of the surroundings of the vehicle as the first virtual image.

2. The vehicle display apparatus according to claim 1, wherein the first display device displays a pair of virtual images as the first virtual image at positions substantially line-symmetric widthwise about the second virtual image in the widthwise direction of the vehicle.

3. The vehicle display apparatus according to claim 2, wherein the first display device displays the pair of virtual images substantially at the same positions in a front-back direction of the vehicle.

4. The vehicle display apparatus according to claim 1, wherein the image pickup device outputs the captured image of an external region of the vehicle on a rear side that is visible by the driver by a door mirror of the vehicle.
